(19) United States
(12) Patent Application Publication
(10) Pub. No.: US 2004/0190633 A1
(43) Pub. Date: Sep. 30, 2004

(54) Composite objective video quality measurement

(76) Inventors: Walid Ali, Montrose, NY (US); Cornelis C.A.M. Van Zon, Cod Spring, NY (US)

Correspondence Address: U S Philips Corporation, Intellectual Property Department, 580 White Plains Road, Tarrytown, NY, 10591, US

(21) Appl. No.: 10/476,354

(22) PCT Filed: May 1, 2002
(86) PCT No.: PCT/US02/13774

Related U.S. Application Data
(60) Provisional application No. 60/287,836, filed on May 1, 2001.

(51) Int. Cl. H04N 7/12

(52) U.S. Cl. 375/240.29; 375/240.01

(57) ABSTRACT

The modification of cost related aspects of an information signal is controlled so that a composite objective quality measurement of the information signal meets a predetermined quality criterion. Correlation results are combined with results of objective metrics for the modified signal to derive the composite objective quality measurement for the modified signal. The correlation results are determined from a statistical analysis that correlates the subjective ratings with results of the objective quality metrics for similar signals. The objective quality metrics are selected for determining the composite objective quality measurement. The subjective ratings are obtained from multiple human using the similar signals. The objective quality metrics of the similar information signals are selected so as to provide the closest correlation between the subjective ratings and the resulting composite objective quality measurement. The quality criteria is developed to minimize the cost related aspects in a consistent way in order to meet hardware limitations while providing the maximum satisfaction to the viewers. The information signals may be video and/or audio signals and the cost related aspects may be compression ratio or pixel count or processing time or bandwidth or other aspects.

The invention is related to the field of objective quality measurement of audio and video information signals. The invention is also related to the field information compression that is responsive to such objective quality measurements. The invention is also related to the field of information signal recorders and transmitters that are responsive to such objective quality measurements and video receivers that provide control signals to transmitters to control the transmission in response to such objective quality measurements.

In order to simplify the material presented herein, the term “viewers” means viewers of video and/or listeners of audio, and video generally means video and/or audio.

Subjective testing of video quality is the ultimate judge when evaluating audio and video processing systems. Evaluating the resulting quality is achieved by polling viewers' opinions. Yet, subjective scores rely on human preference, which varies widely between different viewers (experts' evaluation is very different from novice viewers). Moreover, viewers' scores even change when testing is repeated. The non-deterministic nature of subjective evaluation, together with its high cost, as well as the infeasibility of using it for automatic video processing (e.g., monitoring the quality of service QoS can only be implemented in an automatic fashion) dictates the need for a robust objective method and apparatus to automatically evaluate the image quality.

Different objective methods have been proposed. They vary widely in performance and complexity. However, none of these models excel under a wide range of circumstances, but rather have a high degree of correlation with subjective evaluation (high performance) under certain conditions, but have a very low correlation with the subjective model under other circumstances.

Those skilled in the art are directed to the following documents:

1. U.S. patent application Ser. No. 09/734,823 by Ali et. al.

The above documents are hereby incorporated in whole by reference.

The invention is a method and apparatus for objective quality measurement of digital information signals such as video and/or audio signals. Several different objective metrics are selected for evaluating video sequence quality. Each metric is a different automatic method of determining video quality and each metric provides a respective objective result that represents some aspect of the quality of the information signal. Each metric should measure a different aspect of signal quality. Preferably the metrics should be selected to be as independent as possible, but there is likely to be some overlap. The metrics are selected based on statistical methods as described below. For example, for an MPEG video signal a measurement of noise is likely to partially correlate with a measurement of clipping, but also to be partially independent of the measurement of clipping.

The objective results of the selected metrics are combined with correlation results to determine a composite objective quality measurement for the information signal. Preferably, each of the metrics provides a single respective measurement value and the correlation results include a single weighing factor for each respective measurement value, and the composite objective quality measurement is the summation of the multiplications of the metric measurement values times their respective weighing factors.

The correlation results are determined statistically to maximize the correlation between quality ratings provided by multiple human viewers and the composite objective quality measurement based on the selected set of metrics. The statistical determination may be performed using regression analysis such as Pierson analysis or more preferably Spearman rank order correlation analysis. The correlation results are based on objective quality results and subjective video quality ratings using similar video sequences. The similarity between the video sequences include at least that they have approximately the same results for the objective quality metrics. Preferably, exactly the same video sequences are used for the objective and subjective quality measurements.

The metrics are selected from known quality related metrics of video sequences. The selection is made so as to balance between the need to maximize the correlation between the composite objective quality measurement and subjective results and at the same time to minimize the cost of determining the composite objective quality measurement. That is, a known metric is selected for use if its use significantly improves the correlation between the composite objective quality measurement and subjective quality ratings and it does not add too much cost or exceed some required limitation in relation to system cost factors such as system complexity or processing time.

The subjective quality ratings are quality scores in a predetermined range. The testing methodology and the number of different human viewers participating in the rating is sufficiently large to provide a predetermined statistical reliability with respect to the composite objective video measurement. Post rating statistical analysis is performed to improve the consistency of the results from one group to another group of viewers. For example, the scores of those viewers who fail to consistently discriminate rationally between no compression and very high compression of the same video signal are eliminated.

Preferably, each metric provides a single measurement value, and the correlation results are a single correlation weighting factor for each respective single measurement value. Then the objective quality measurement is simply the summation of each single measurement value times its respective correlation weighting factor. In this case the method can be expressed in a more mathematical form as follows.

According to the desired level of performance and the allowed complexity and processing time, a set of objective metrics, metric₁, metric₂, . . . metricₙ are selected. Each metric is used to determine a respective figure of merit, f₁, f₂, . . . , fₙ. Weights wᵢ, (1≦i≦n) for each figure of merit fᵢ are determined by statistical analysis to maximize the correlation R between the composite objective quality measurement F and subjective ratings S for similar video sequences.

$$F = {max}_{R} \{ {\sum }_{i = 1}^{n} {w}_{i} {f}_{i} \}$$

The correlation factor R may be calculated using Spearman rank order correlation analysis. The main advantage of Spearman correlation coefficient is that it does not assume any functional form for the relationship between the subjective and objective evaluations, but only assumes a monotonic relation. The correlation coefficient is defined as:

$${r}_{s} = 1 - \frac{6 * {Σ ( {X}_{r} - {Y}_{r} )}^{2}}{n ( {n}^{2} - 1 )}$$

where X and Y are the elements of the subjective and objective data sets respectively and the summation is over n pairs.

The composite objective video quality measurement is used for adjusting some cost related aspect of the use of the video sequence. The cost related aspects of information signals may include for example, compression ratio, bandwidth, routing time, processing time, storage space, delay time. Additional cost related aspects of digital video signals include the number of pixels, extent of edge clipping, and the number of brightness and color bits that determine the number of gray levels and shades of color that are represented. Additional cost related aspects of audio signals may include number and independence of sound channels, maximum and/or minimum frequency, sampling rate. First a quality criterion for the objective video quality measurement is selected and then the video sequence is modified to adjust the cost related aspect of the video sequence so that the objective video quality measurement of the processed video sequence meets the criterion for objective video quality. The quality criterion may be a simple threshold value that the objective video quality measurement has to be equal to or above. For example, the compression of an MPEG encoded multimedia sequence can be controlled so that a minimum objective video quality is maintained.

Preferably, the objective quality metrics for a video signal include a block-edge impairment metric, a noise metric, a clipping measurement metric, and a contrast measurement metric. These well known metrics have been selected for their relative independence, simplicity and high processing rate so that they can be executed in real time on a video encoder. Examples of each of these metrics are known in the art, but the invention includes specific implementations of these metrics described below. In cases where processing is to be performed offline, then more complex metrics higher processing time metrics may also be included.

The noise metric may include dividing the image into a multitude of square or rectangular blocks; filtering the variations in multiple pixels in each of the determined blocks through multiple filters approximately according to human visual perception characteristics; convoluting the image with each of the filters at each of the pixels to get an estimate of perceptibly significant noise; clipping the estimate of perceptibility depending on a lower human perceptibility threshold lowHPT and upper human perceptibility thresholds highHPT so that only the noise that is perceptible is included; averaging the clipped responses over the small square or rectangular areas of the image; selecting m blocks that have the smallest average clipped responses, where m is larger than one; and the noise measurement is the average clipped responses of the m selected blocks.

The clipping function for the noise metric is:

$$clip ( x ) = \{ \begin{matrix}0 ⟶ if ( x < lowHPT ) \\ x ⟶ if ( x > highHPT ) \\ ( \frac{( x - lowHPT ) * highHPT}{( highHPT - lowHPT )} ) ⟶ otherwise\end{matrix}$$

the upper human perceptibility threshold highHPT and the lower human perceptibility threshold lowHPT are based on the following model:

HPT=∫Y(f′)S(f′)df′, where Y(f)=10^{0.466(log(f)+0.4)}^{²}^{-0.31},

S(f′) is the spatial spectrum response of the filter, and f′ is a normalized version of the spatial frequency f to compensate for viewing distance.

The clipping metric determines a measurement depending on the number of times the luminance signal hits its maximum allowed value and/or the number of times the luminance signal hits its minimum allowed value in the video sequence.

The contrast metric determines a measurement that depends on the normalized difference between the widths of a lower luminance histogram section containing a first predetermined portion of the total energy and an upper luminance histogram section containing a second predetermined portion of the energy of the histogram, the histogram being a measure of luminance with respect to time over multiple images of the video sequence. Preferably the first and second predetermined portions are the upper 5% and the bottom 5% of the energy of the luminance.

The block-edge impairment metric Mₕ is based on adding up the squared differences across block boundaries of an image. The block-edge impairment may be defined as:

$${M}_{h} = ‖ {WD}_{c} ( f ) ‖ = \sqrt{{\sum }_{i = 1}^{N / 8 - 1} {‖ {w}_{i} ( {f}_{c ( 8 i )} - {f}_{c ( 8 i + 1 )} ) ‖}^{2}} / E ,$$

where f is the image, D_{c} is the difference operator across columns, W is a weighting matrix defined according to the visual prominence of the blocking effect, wᵢ is the weight vector corresponding to the pixels of the image column f_{c}, for the difference of pixels at (i,j) and (i,j+1) the weight wᵢⱼ is defined as:

$${w}_{ij} = \{ \begin{matrix}1.152 * ln ( 1 + \frac{\sqrt{{μ}_{ij}}}{1 + {σ}_{ij}} ) & if {μ}_{ij} <= 81.0 \\ ln ( 1 + \frac{\sqrt{255 - {μ}_{ij}}}{1 + {σ}_{ij}} ) & otherwise\end{matrix}$$

where μᵢⱼ is the mean of the 1-line strip of pixels on either side of the difference, σᵢⱼ is their standard deviation, μᵢⱼ is a measure of the average brightness of the portion of the picture, σᵢⱼ is a measure of variation of intensity and is hence used in the denominator of the weight; and the normalizing factor E, is defined as:

$$E = \frac{1}{7} {\sum }_{k = 1}^{7} {S}_{k}$$

where Sₖ is defined as:

$${S}_{k} = \sqrt{{\sum }_{i = 1}^{N / 8 - 1} {‖ {w}_{i} ( {f}_{c ( 8 i + k )} - {f}_{c ( 8 i + k + 1 )} ) ‖}^{2}} .$$

Preferably, the composite video quality metric also includes a second statistical analysis to correlate the results of the subjective ratings with the results of an additional objective quality metric and with the results of the correlation of the subjective ratings with the results of the two or more linearly related objective quality metrics for similar video sequences. The additional objective quality metric is not linearly related to the two or more objective quality metrics. In this case the type of analysis used in the second statistical analysis may be the same type of analysis as used in the first statistical analysis. Preferably, the additional objective video quality is a sharpness metric which may, for example, be determined using a high frequency analysis.

These and other objects and advantages of the present invention will become clear to those skilled in the art in view of the following detailed description with reference to the following drawings:

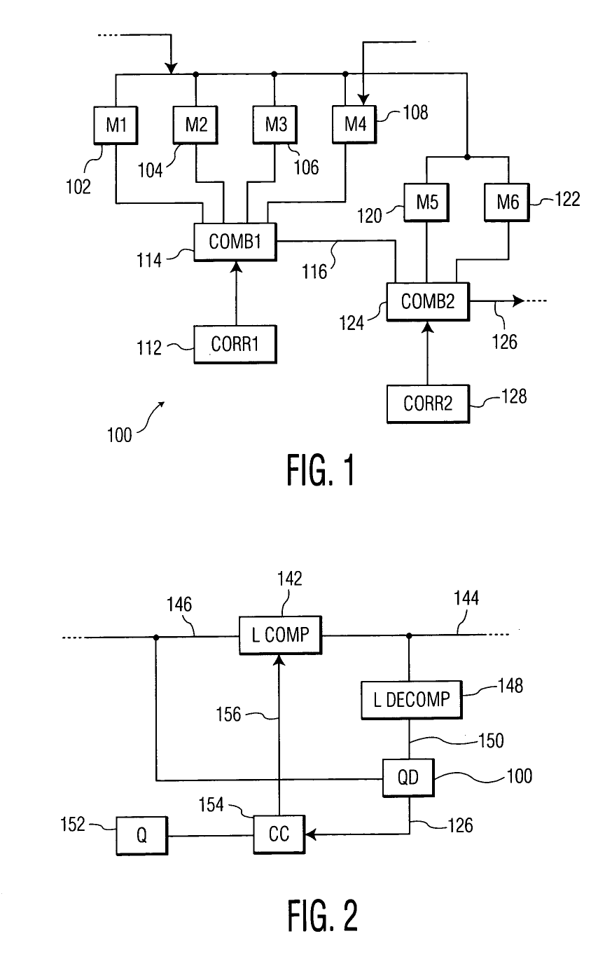

FIG. 1 illustrates an example composite objective quality determining unit of the invention.

FIG. 2 shows an information signal compressor of the invention including the composite objective quality determining unit of FIG. 1.

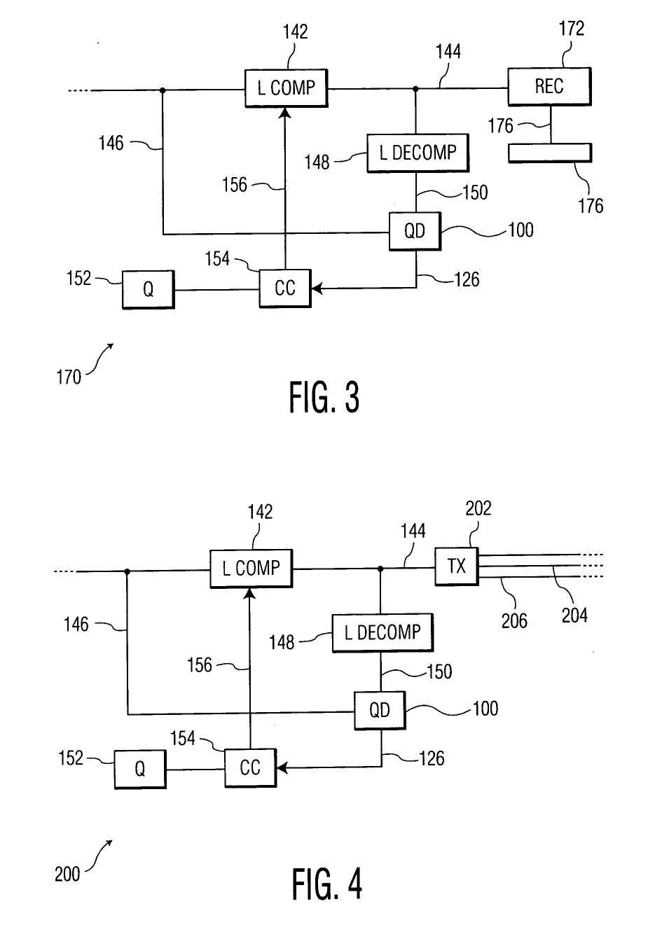

FIG. 3 depicts an information signal recorder of the invention including the composite objective quality determining unit of FIG. 1.

FIG. 4 shows an information signal transmitter of the invention including the composite objective quality determining unit of FIG. 1.

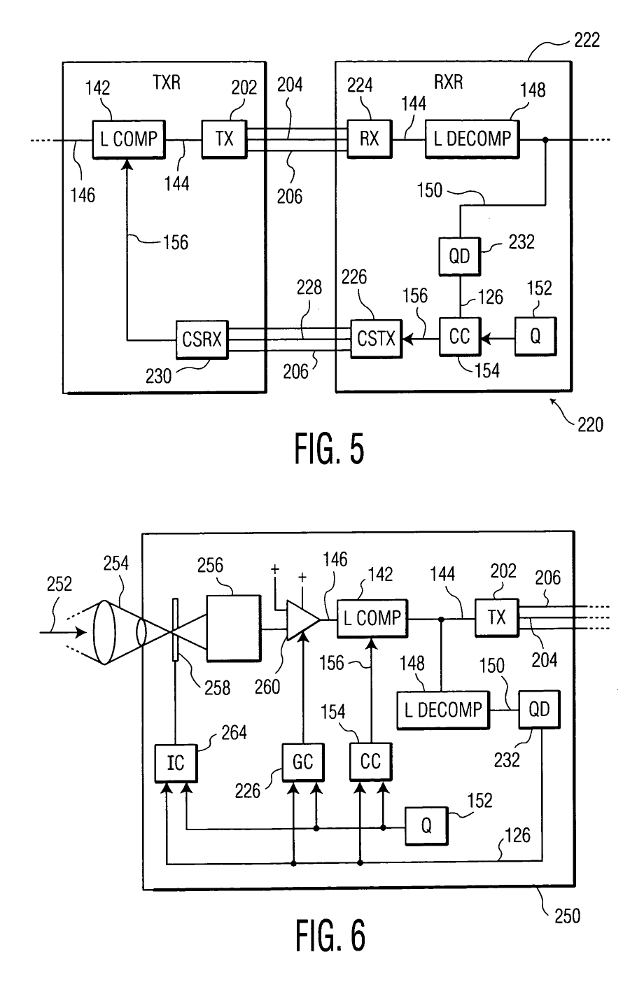

FIG. 5 illustrates an information signal distribution network of the invention with an information signal receiver of the invention that including the composite objective quality determining unit of FIG. 1.

FIG. 6 depicts a video camera of the invention with a video transmitter of the invention including the composite objective quality determining unit of FIG. 1.

FIG. 1 shows composite objective measurement unit 100 of the invention. Multiple first discrete objective quality determining units 102-108 receive an information signal and based on a different respective objective quality metrics, determine respective discrete objective quality measurements. Each metric automatically provides a relatively independent objective quality measurement and is performed automatically. For a video signal, the first discrete objective quality determining units in this example may include a noise metric, a clipping metric, a contrast metric, and a block edge impairment metric. First correlation unit 112 provides correlation results discussed below. First combining unit 114 combines the discrete objective quality measurements of the first metric determining units with the correlation results of the first correlation unit to produce the first composite objective quality measurement 116.

For example, each of the discrete objective quality measurements may be a single measurement value and the correlation results may be a single weighting factor for each single measurement value and the combining may be summation of each measurement value multiplied by its respective weighing factor. Of course, if the metrics are not linearly related, a more complex combining is required.

The correlation results are determined from statistical analysis to maximize the correlation between subjective quality ratings provided by a multitude of human viewers and the first composite objective video quality measurement that is formed by combining the discrete objective quality measurements and the correlation results. Preferably the statistical analysis includes regression analysis such as Pierson regression analysis or more preferably Spearman rank order correlation analysis. The statistical analysis is performed based on subjective quality ratings for a first video signal and objective quality ratings of a similar video signal. The similarity between the first and second video signal include at least that the discrete objective quality measurements are similar for the similar signals and preferably the similar signals are actually the same signal. Preferably, the procedure for obtaining the subjective rating is carefully designed and controlled to provide the highest reasonable level of rational statistical accuracy and repeatability for different groups of human viewers. For example, a 10% standard deviation in correlation (between the subjective quality ratings and the composite objective quality measurement) or a 10% standard deviation in the correlation results (e.g. the weights for the respective metrics) from one similar group of viewers to another.

The metrics are selected from known objective quality metrics. As additional objective quality metrics are developed they can be evaluated for integration into the invention herein. The metrics are selected so as to provide the highest correlation between the subjective quality ratings and the composite objective video measurement without unreasonable complexity or processing time in the system (i.e. the composite objective video measurement unit). The metric results of all the first metrics 102-108 should be linearly related in order to minimize the complexity and calculation time required in the combining unit. If one or more of the selected metrics is not linearly related to these first metrics, then additional processing for second metrics is preferred as described below. The selected metrics of noise, clipping, contrast, and block-edge impairment have been selected because together they provide a high correlation between the composite objective quality measurement and subjective results and they are simple and can be processed at a sufficient rate to allow real time control of the cost related factor in an MPEG video encoder. When video processing may be performed off-line or when audio processing is performed other metrics should be selected.

The quality metrics used by the objective quality determining units 102-106 are all single ended metrics (i.e. they do not need access to an original signal) so only the modified signal is provided to those units. As shown, the quality metric for objective quality determining unit 108 is a double ended metric (i.e. a metric that needs input of both the original and modified signal) so an input of the original video signal is shown for that metric. The preferred metrics for a video signal are a noise metric, a clipping metric, a contrast metric, and a block edge impairment metric, and all of these metrics are single ended metrics so in the preferred video embodiment the input of the original video signal into unit 108 would not be required.

When one or more of the selected metrics is not linearly related, then preferably, the selected metrics are divided into groups of one or more linearly related metrics. An additional processing stage is then used for each subsequent group of metrics. Preferably the group of metrics for the first processing stage include multiple metrics. In each subsequent group processing stage, the metric results of the subsequent group and the composite objective quality measurement of the preceding group are combined with additional correlation results to maximize the correlation between the subjective ratings and a composite objective quality measurement provided by the subsequent group. For example, for a subsequent stage, each metric of the group may provide a single measurement value and the correlation results for the group may include a single weight factor for each metric of the group plus a single weight factor for the composite objective quality measurement of the preceding group. In that case the combining may be performed by the summation of the multiplication of the composite objective quality measurement of the preceding group by its respective weighing factor plus the multiplications of the resulting measurement value of each metric in the group by its respective weighing factor.

Each subsequent additional processing stage requires an additional statistical analysis to correlate the subjective quality ratings with the results of the subsequent objective quality metrics and with the composite objective quality measurement of the previous processing stage in order to predetermine the correlation results (e.g. single weight factors). Preferably the method of statistical analysis used to determine the correlation results for each processing state is similar to that described above for the first processing stage.

The second stage of this example embodiment includes one or more second objective quality determining units 120-122 each provide a discrete objective quality measurement. Second correlation unit 122 provides correlation results for maximizing the correlation between the subjective ratings (described above) and the second composite objective quality measurement. Second combining unit 124 combines the correlation results with the second discrete objective quality measurements and the composite objective quality measurement of the preceding stage in order to derive a second composite objective quality measurement 126.

For a video signal, preferably the only metric in the second group of metrics is a sharpness metric. Other second metrics could be selected, but as in the first metrics all the metric results of the second metric determining units should be linearly related.

As described above, the objective quality metrics for a video signal preferably include a noise metric. In the noise metric, the image is divided into a multitude of square or rectangular blocks; and variations in multiple pixels in each of the determined blocks is filtered through multiple filters approximately according to human visual perception characteristics. Then the image is convoluted with each of the filters at each of the pixels to get an estimate of perceptibly significant noise. The estimate of perceptibility is clipped depending on a lower human perceptibility threshold lowHPT and upper human perceptibility threshold highhHPT so that only the noise that is perceptible is included.

The clipped responses are averaged over the small square or rectangular areas of the image. Then m blocks that have the smallest average clipped responses are selected, where m is larger than one; and the noise metric is approximately the average clipped responses of the m selected blocks. The number m may be a predetermined number or it may be determined for each image by a predetermined method.

More specifically, the clipping function is:

$$clip ( x ) = \{ \begin{matrix}0 ⟶ if ( x < lowHPT ) \\ x ⟶ if ( x > highHPT ) \\ ( \frac{( x - lowHPT ) * highHPT}{( highHPT - lowHPT )} ) ⟶ otherwise\end{matrix}$$

and the upper human perceptibility threshold highHPT and the lower human perceptibility threshold lowHPT are based on the following model:

HPT=∫Y(f′)S(f′)df′, where Y(f)=10^{0.466(log(f)+0.4)}^{²}^{-0.31},

S(f′) is the spatial spectrum response of the filter, and f′ is a normalized version of the spatial frequency f to compensate for viewing distance.

As described above, the objective quality metrics include a clipping metric depending on one or both of: the number of times the luminance signal hits its maximum and the number of times the luminance signal hits its minimum allowed value.

Also as described above, the objective quality metrics for a video signal include a contrast metric depending on the normalized difference between the widths of a lower luminance histogram section containing a first predetermined portion of the total energy and an upper luminance histogram section containing a second predetermined portion of the energy of the histogram, the histogram being a measure of luminance with respect to time over multiple images of the video signal.

As stated above, the objective quality metrics for a video signal also include a block-edge impairment metric based on adding up the squared differences across block boundaries of an image. The block-edge impairment metric Mₕ is defined as:

$${M}_{h} = ‖ {WD}_{c} ( f ) ‖ = \sqrt{{\sum }_{i = 1}^{N / 8 - 1} {‖ {w}_{i} ( {f}_{c ( 8 i )} - {f}_{c ( 8 i + 1 )} ) ‖}^{2}} / E ,$$

where f is the image, D_{c} is the difference operator across columns, W is a weighting matrix defined according to the visual prominence of the blocking effect, wᵢ is the weight vector corresponding to the pixels of the image column f_{c}, for the difference of pixels at (i,j) and (i,j+1) the weight wᵢⱼ is defined as:

$${w}_{ij} = \{ \begin{matrix}1.152 * ln ( 1 + \frac{\sqrt{{μ}_{ij}}}{1 + {σ}_{ij}} ) & if {μ}_{ij} <= 81.0 \\ ln ( 1 + \frac{\sqrt{255 - {μ}_{ij}}}{1 + {σ}_{ij}} ) & otherwise\end{matrix}$$

where μᵢⱼ is the mean of the 1-line strip of pixels on either side of the difference, σᵢⱼ is their standard deviation, μᵢⱼ is a measure of the average brightness of the portion of the picture, σᵢⱼ is a measure of variation of intensity and is hence used in the denominator of the weight; and the normalizing factor E, is defined as:

$$E = \frac{1}{7} {\sum }_{k = 1}^{7} {S}_{k}$$

where Sk is defined as:

$${S}_{k} = \sqrt{{\sum }_{i = 1}^{N / 8 - 1} {‖ {w}_{i} ( {f}_{c ( 8 i + k )} - {f}_{c ( 8 i + k + 1 )} ) ‖}^{2}} .$$

For an audio signal the selected objective metrics may include a noise metric, and a high and low frequency clipping metric.

FIG. 2 shows an example information signal compressor 140 of the invention. The information compressor includes the composite objective quality determining unit 100 of FIG. 1 to provide composite objective quality measurement 126. A lossy compression unit 142 provides a lossy compressed information signal 144 depending on an input information signal 146. A lossy decompression unit 148 provides a lossy decompressed information signal 150 based on the lossy compressed information signal 144, to the composite objective quality determining unit 100. In some cases metrics can be designed to operate directly on the compressed information signal in which case lossy decompression unit 184 can be eliminated. Quality criterion 152 and composite objective quality measurement 126 are provided to the lossy compression unit 142. The compression of lossy compression unit 142 is controlled depending on the quality criterion 152 and the composite objective quality measurement 126 so that in the lossy compressed information signal 144, the composite objective quality measurement substantially meets the quality criterion.

For a video signal the lossy compression may be an MPEG compression of the video.

The quality criterion may be simply that the composite objective quality measurement threshold should stay above a predetermined threshold value or it may require that the threshold be met at least a predetermined percentage of the time or it may be more complex.

FIG. 3 depicts an information signal recorder 170 of the invention including the composite objective quality determining unit 100 of FIG. 1. A recording unit 172 records a signal 174 on media 174.

Signal 174 includes the lossy compressed information signal 144, but may be in a different form, such as channel encoded and include addition information, such as error correction information. The composite objective quality measurement for the lossy compressed information signal 144 contained in recorded signal 174 substantially meets the quality criterion 152.

The media may be an optical disc such as a DVD or CD disc with the lossy compressed information signal recorded in circular or spiral tracks.

FIG. 4 shows an information signal transmitter 200 of the invention including the composite objective quality determining unit 100 of FIG. 1. A transmitting unit 202 transmits a signal 204 through a transmission media 206.

Signal 1204 includes the lossy compressed information signal 144, but may be in a different form, such as channel encoded and include addition information, such as error correction information. The composite objective quality measurement for the lossy compressed information signal 144 contained in transmitted signal 174 substantially meets the quality criterion 152.

The transmission media may be an optical fiber for an optical transmission signal or the transmission media may be a conductor for an electronic transmission signal or the transmission media may be open space for an electromagnetic radio transmission signal or the transmission media may be a record carrier for a magnetically stored, optically stored, or solid-state stored signal.

FIG. 5 illustrates an information signal distribution network 220 of the invention with an information signal receiver of the invention that including the composite objective quality determining unit of FIG. 1.

FIG. 6 depicts a video camera of the invention with a video transmitter of the invention including the composite objective quality determining unit of FIG. 1.

The invention has been disclosed with reference to specific preferred embodiments, to enable those skilled in the art to make and use the invention, and to describe the best mode contemplated for carrying out the invention. Those skilled in the art may modify or add to these embodiments or provide other embodiments without departing from the spirit of the invention. Thus, the scope of the invention is only limited by the following claims:

We claim:

1. A method comprising:
determining a composite objective quality metric for determining quality of information signals based on a first statistical analysis to correlate subjective ratings of the quality of information signals with objective measurements of quality of similar information signals based on two or more different respective discrete objective metrics;
selecting a quality criteria for a composite objective quality measurement for other information signals, based on the composite objective quality metric;
modifying cost related aspects of the other information signals so that the composite objective quality measurement meets the requirements of the quality criterion.

2. The method of claim 1, in which:
each of the two or more different discrete objective metrics produces a respective single measurement value, and the correlations are weighting factors, and the composite objective quality measurement is the sum of each of the measurement values multiplied by its respective weighting factor;
all the two or more different respective discrete objective metrics are linearly related;
the first statistical analysis includes regression analysis, and the regression analysis is Spearman rank order correlation analysis;
the information signals are video signals;
the cost related aspects of the video signals are selected from one or more of: compression ratio, bandwidth, routing time, storage space, pixel count;
the similar information signals have at least approximately the same objective measurements of quality for the two or more different respective discrete objective metrics;
the similar information signals are the same information signals;
the subjective ratings of quality are based on quality scores within a predetermined range and the testing methodology and the number of different human quality raters is sufficiently large to provide a predetermined statistical reliability for the composite objective quality metric;
the two or more different respective discrete objective metrics include a noise metric, a clipping metric, a contrast metric, and a block edge impairment metric.

3. The method of claim 1, in which
a set of two or more discrete objective metrics, metric1, metric2, . . . metricn are selected;
each metric is used to determine a respective figure of merit, f1, f2, . . . , fn;
weights wi, (1≦i≦n) for each figure of merit fi are determined by statistical analysis to maximize the correlation R between the composite objective quality measurement F and subjective ratings S for the same information signal sequence;
$$F = {max}_{R} \{ {\sum }_{i = 1}^{n} {w}_{i} {f}_{i} \}$$
the correlation factor R is calculated using Spearman rank order correlation analysis;
the correlation coefficient is defined as:
$${r}_{S} = 1 - \frac{6 * {Σ ( {X}_{r} - {Y}_{r} )}^{2}}{n ( {n}^{2} - 1 )}$$
where X and Y are the elements of the subjective and objective data sets respectively and the summation is over n pairs.

4. The method of claim 1, in which the information signal is a video signal and the two or more different respective discrete objective metrics include a noise metric that includes the steps of:
dividing the image into a multitude of square or rectangular blocks;
the variations in multiple pixels in each of the determined blocks are filtered through multiple filters approximately according to human visual perception characteristics;
the image is convoluted with each of the filters at each of the pixels to get an estimate of perceptibly significant noise;
the estimate of perceptibility is clipped by a clipping function depending on a lower human perceptibility threshold lowHPT and upper human perceptibility threshold s highHPT so that only the noise that is perceptible is included the clipped responses are averaged over the small square or rectangular areas of the image;
the m blocks that have the smallest average clipped responses are selected, where m is larger than one; and
the noise metric is approximately the average clipped responses of the m selected blocks.

5. The method of claim 4, in which:
the clipping function is:
$$clip ( x ) = \{ \begin{matrix}0 \to if ( x < lowHPT ) \\ x \to if ( x > highHPT ) \\ ( \frac{( x - lowHPT ) * highHPT}{( highHPT - lowHPT )} ) \to otherwise\end{matrix}$$
the upper human perceptibility threshold highHPT and the lower human perceptibility threshold lowHPT are based on the following model:
HPT=∫Y(f′)S(f′)df′, where Y(f)=10^{0.466(log(f)+0.4)}^{²}^{-0.31},
S(f′) is the spatial spectrum response of the filter, and f′ is a normalized version of the spatial frequency f to compensate for viewing distance.

6. The method of claim 1, in which the two or more different respective discrete objective metrics include a clipping metric, the information signal is a video signal, and the results of the clipping metric depend on one or both of: the number of times the luminance signal hits its maximum and the number of times the luminance signal hits its minimum allowed value.

7. The method of claim 1, in which the information signal is a video signal and the two or more different respective discrete objective metrics include a contrast metric depending on the normalized difference between the widths of a lower luminance histogram section containing a first predetermined portion of the total energy and an upper luminance histogram section containing a second predetermined portion of the energy of the histogram, the histogram being a measure of luminance with respect to time over multiple images of the information signal.

8. The method of claim 1, in which the information signal is a block encoded video signal and the two or more different respective discrete objective metrics include a block edge impairment metric based on adding up the squared differences across block boundaries of an image.

9. The method of claim 9, in which block edge impairment metric Mh is defined as:
$${M}_{h} = ‖ {WD}_{c} ( f ) ‖ = \sqrt{{\sum }_{i = 1}^{N / 8 - 1} {‖ {w}_{i} ( {f}_{c ( 8 i )} - {f}_{c ( 8 i + 1 )} ) ‖}^{2}} / E ,$$
where f is the image, Dc is the difference operator across columns, W is a weighting matrix defined according to the visual prominence of the blocking effect, wi is the weight vector corresponding to the pixels of the image column fc, for the difference of pixels at (i,j) and (i,j+1) the weight wij is defined as:
$${w}_{ij} = \{ \begin{matrix}1.152 * ln ( 1 + \frac{\sqrt{{μ}_{ij}}}{1 + {σ}_{ij}} ) & if {μ}_{ij} <= 81.0 \\ ln ( 1 + \frac{\sqrt{255 - {μ}_{ij}}}{1 + {σ}_{ij}} ) & otherwise\end{matrix}$$
where μij is the mean of the 1 line strip of pixels on either side of the difference, σij is their standard deviation, μij is a measure of the average brightness of the portion of the picture, σij is a measure of variation of intensity and is hence used in the denominator of the weight; and the normalizing factor E, is defined as:
$$E = \frac{1}{7} {\sum }_{k = 1}^{7} {S}_{k}$$
where Sk is defined as:
$${S}_{k} = \sqrt{{\sum }_{i = 1}^{N / 8 - 1} {‖ {w}_{i} ( {f}_{c ( 8 i + k )} - {f}_{c ( 8 i + k + 1 )} ) ‖}^{2}} .$$

10. The method of claim 1, in which the composite objective quality metric is also based on second statistical analysis to correlate the subjective ratings of quality of the information signal with both the composite objective quality measurement and an additional objective measurement of quality of the similar information signal based on at least one additional respective discrete objective quality metric, the at least one additional respective discrete objective quality metric not being linearly related to any of the two or more different respective discrete objective metrics.

11. The method of claim 10, in which the method of statistical analysis used in the second statistical analysis is similar to the method of statistical analysis used in the first statistical analysis.

12. The method of claim 10, in which the at least one additional respective discrete objective quality metric is a sharpness metric.

13. A composite objective quality determining unit comprising:
a multitude of objective quality determining units each using a different respective discrete objective quality metric for providing respective objective quality measurements depending on an input information signal;
a correlation unit for providing correlation results for each respective objective quality measurement;
a combination unit for combining the objective quality measurements with the respective correlation results to derive a composite objective quality measurement.

14. A information signal modifier comprising:
a information signal modification unit for modifying an input information signal by a variable amount depending on a composite objective quality measurement and a predetermined quality criterion, and providing the modified information signal;
a composite objective quality determining unit including:
a multitude of objective quality determining units, each using a different respective discrete objective quality metric for providing respective objective quality measurements depending on the modified information signal;
a correlation unit for providing correlation results for each respective objective quality measurement;
a combination unit for combining the objective quality measurements with the respective correlation results to derive the composite objective quality measurement.

15. The information signal modifier of claim 14 wherein:
the information signal modification unit is an information signal compression unit;
the information signal modifier further comprises a modification control unit that provides a modification control signal depending on the composite objective quality measurement and the predetermined quality criterion; and
the information signal modification unit varies the modification depending on the modification control signal so as to depend on the composite objective quality measurement and the predetermined quality criterion.

16. The information signal modifier of claim 14 wherein:
the signal modification unit is a lossy information signal compression unit and the modified information signal is a lossy compressed information signal;
the information signal modifier further comprises a lossy information signal decompression unit for providing a lossy decompressed information signal depending on the lossy compressed information signal; and
the objective quality determining units provide the respective objective quality measurements depending on the lossy decompressed information signal.

17. A information signal recorder comprising:
a information signal modifying unit for modifying an input information signal by a variable amount depending on a composite objective quality measurement and a predetermined quality criterion, and providing a modified information signal;
a recording unit to record the modified information signal on a recording medium;
a composite objective quality determining unit including:
a multitude of objective quality determining units each using a different respective discrete objective quality metric for providing respective objective quality measurements depending on the modified information signal;
a correlation unit for providing correlation results for each respective objective quality measurement;
a combination unit for combining the objective quality measurements with the respective correlation results to derive the composite objective quality measurement.

18. A information signal transmitter comprising:
a information signal modification unit for modifying an input information signal by a variable amount depending on a composite objective quality measurement and a predetermined quality criterion, and providing the modified information signal;
a transmitting unit to transmit the modified information signal on a transmission medium;
a composite objective quality determining unit including:
a multitude of objective quality determining units each using a different respective metric for providing respective discrete objective quality measurements depending on the modified information signal;
a correlation unit for providing correlation results for each respective discrete objective quality measurement;
a combination unit for combining the discrete objective quality measurements with the respective correlation results to derive the composite objective quality measurement.

19. A video camera comprising:
an imaging system to provide a digital video signal depending on incident light;
an optical system to focus light incident on the imaging system;
a video signal modification unit for modifying the video signal by a variable amount depending on a composite objective quality measurement and a predetermined quality criterion, and providing a modified information signal;
a transmitting unit to transmit the modified video signal on a medium;
a composite objective quality determining unit including:
a multitude of objective quality determining units each using a different respective metric for providing respective discrete objective quality measurements depending on the modified video signal;
a correlation unit for providing correlation results for each respective discrete objective quality measurement;
a combination unit for combining the discrete objective quality measurements with the respective correlation results to derive the composite objective quality measurement.

20. The camera of claim 19 in which the medium is an optical record carrier.

21. A information signal receiver comprising:
a receiver unit for recovering a modified information signal from a transmission medium;
a decompressing unit for decompressing the modified information signal to provide a lossy decompressed information signal;
a compression control unit that provides a compression control signal depending on the composite objective quality measurement and a predetermined quality criterion;
a composite objective quality determining unit including:
a multitude of metric determining units for providing respective discrete objective quality measurements depending on the lossy decompressed information signal;
a correlation unit for providing correlation results for each respective discrete objective quality measurement;
a combination unit for combining the discrete objective quality measurements with the respective correlation results to derive the composite objective quality measurement.

22. A information signal network comprising:
a information signal modification unit for compressing an input information signal by a variable amount depending on a compression control signal;
a transmitting unit to transmit the modified information signal on a transmission medium;
a receiver unit for recovering the modified information signal from a transmission medium;
a decompressing unit for decompressing the modified information signal to provide a lossy decompressed information signal;
a compression control unit that provides a compression control signal depending on the composite objective quality measurement and a predetermined quality criterion;
a control signal transmission unit for transmitting the compression control signal from the compression control unit on the transmission medium;
a control signal receiving unit for recovering the compression control signal from the transmission medium, and communicating for providing the compression control signal to the information signal modification unit;
a composite objective quality determining unit including:
a multitude of metric determining units for providing respective discrete objective quality measurements depending on the lossy decompressed information signal;
a correlation unit for providing correlation results for each respective discrete objective quality measurement;
a combination unit for combining the discrete objective quality measurements with the respective correlation results to derive the composite objective quality measurement.

23. A modified information signal produced by the method of claim 1.

24. A modified information signal with a variable lossy compression adjusted to provide a composite objective quality measurement equal to or above a predetermined quality criterion.

25. A record carrier produced by the method of:
determining a composite objective quality metric for determining the quality of information signals based on a first statistical analysis to correlate subjective ratings of the quality of information signals with objective measurements of quality of a similar information signals based on two or more different respective discrete objective metrics;
selecting a quality criteria for a composite objective quality measurement for another information signal based on the composite objective quality metric;
modifying cost related aspects of the other information signals to provide a modified signal so that the composite objective quality measurement of the modified signal meets the requirements of the quality criterion; and
producing a record carrier containing the modified information signal.

26. The method of claim 1 wherein the information signal is an audio signal.
